(19) United States
(12) Patent Application Publication
(10) Pub. No.: US 2007/0298196 A1
(43) Pub. Date: Dec. 27, 2007

(54) Packaging Laminate for a Retortable Packaging Container

(75) Inventors: Kerstin Petersen, Kavlinge (SE); Katarina Flemmer Karlsson, Lund (SE); Thorbjorn Andersson, Sodra Sandby (SE)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance S.A., Pully (SE)

(21) Appl. No.: 11/791,950

(22) PCT Filed: Oct. 28, 2005
(86) PCT No.: PCT/SE05/01622

§ 371 Date: May 31, 2007

(30) Foreign Application Priority Data
Dec. 1, 2004 (SE) 0402938-5

(51) Int. Cl. B32B 27/10; B65B 55/00

(52) U.S. Cl. 428/34.2; 426/392

(57) ABSTRACT

A packaging laminate for a retortable or hot fillable packaging container comprises a core layer of paper or paper board, a first outer liquid-tight coating based on polypropylene on the inside of the packaging laminate, a second outer liquid-tight coating and based on polypropylene on the outside of the packaging laminate, an aluminium foil serving as gas barrier between the core layer and said first outer liquid-tight coating based on polypropylene. A layer of polar polymer material serving as barrier against acidic compounds is provided between the aluminium foil and said first outer liquid-tight coating based on polypropylene. The present invention also relates to the packaging container proper as well as to a method in its production.

### TECHNICAL FIELD

The present invention relates to a packaging laminate for a retortable or hot fillable packaging container comprising a core or bulk layer of paper or paperboard, a first outer liquid-tight coating based on polypropylene on the inside of the packaging laminate, a second outer liquid-tight coating based on polypropylene on the outside of the packaging laminate, and an aluminium foil serving as gas barrier between the core layer and said first outer liquid-tight coating based on polypropylene. The present invention also relates to the packaging container proper, as well as to a method of its manufacture.

### BACKGROUND ART

A packaging laminate of the type described above is previously known from, for example, international Patent Application carrying Publication Number WO97/02140. The prior art packaging laminate displays a rigid, but foldable core layer of paper or paperboard and outer liquid-tight coatings of moisture and heat-resistant plastic material on both sides of the core layer. In order to impart to the prior art packaging laminate tightness properties also against gases, in particular oxygen gas, the packaging laminate moreover displays an aluminium foil serving as gas barrier between the paper or paperboard layer and the one outer plastic coating.

From the prior art packaging laminate, retortable packaging containers are produced with the aid of conventional filling machines of the type which, from a web or from prefabricated blanks of the packaging material, form, fill and seal finished packages in accordance with the so-called form/fill/seal principle which is well-known in packaging contexts.

From, for example, a flat-folded tubular packaging blank of the prior art packaging laminate, retortable packaging containers are produced in that the packaging blank is first raised into an open, tubular packaging carton which is sealed at its one end by fold forming and thermosealing of continuous foldable end panels of the packaging carton for the formation of a substantially planar bottom seal. The packaging carton provided with the bottom is filled with the relevant contents, e.g. food, through its open end which is thereafter closed and sealed by additional fold forming and thermosealing of corresponding end panels of the packaging carton for the formation of a substantially planar top seal. Naturally, the top seal of the packaging carton may instead be formed first, in which event the filling operation is instead put into effect via the bottom. The filled and sealed, normally parallelepipedic packaging container is thereafter ready for a heat treatment in order to impart to the packed contents or food extended shelf-life in its unopened packaging container, such as a shelf-life of at least 6 months, often even longer, such as at least 12 or 18 months.

A heat treatment with a view to extending shelf-life may suitably be put into effect in the manner and under the conditions described in international Patent Application carrying Publication Number WO98/16431, which is hereby incorporated as reference. In such instance, the packaging container is placed in a retort and heated therein with the aid of a first gaseous medium, for example hot steam, flowing in contact with the outer walls of the packaging container, to a temperature generally within the range of between 70 and 130° C. After a predetermined stay-time at the selected temperature, the supply of the gaseous medium is discontinued. The packaging container is cooled using a second circulating gaseous medium, for example cold air, and finally with a circulating liquid medium, for example cold water. The cooled, retorted packaging container is thereafter removed from the retort for storage, transport and/or other handling.

One variation for such retorting is so-called hot fill which is particularly employed for acidic products. In such instance, a sterile filling of the product takes place at least 80° C., but less than 100° C., whereafter retorting is not required.

Even if a packaging container of the prior art packaging laminate in normal cases withstands the rough heat treatment which is constituted by retorting, it nevertheless not seldom occurs that the aluminium foil incorporated as gas barrier during the reforming of the packaging laminate into packaging containers is subjected to such powerful tensile stresses that it cracks in particularly exposed areas of the packaging laminate. The occurrence of cracks in the stretch-sensitive aluminium foil entails that the packaging container to a corresponding degree loses tightness properties against gases which may thereby penetrate into the packaging container and come into contact with the packed product. The problem with undesirable penetration of gases through cracks occurring in the aluminium foil becomes particularly serious in those cases when the packed product is particularly sensitive to the action of gases, for example oxygen gas, which may very rapidly destroy the product and render it unusable. International Publication WO 03/035503 describes a solution to this problem according to which the packaging laminate, with a view to promoting gas tightness, includes an additional layer serving as a gas barrier between the core layer and the aluminium foil.

However, it has proved that other problems may arise in connection with the packing of acidic food products, such as food products containing or preserved in acetic acid or other acid, or food products which, during storage, release free fatty acids, which may particularly be the case for food products of the tomato family. Hereinafter, such compounds will be designated acidic compounds regardless of whether they relate to acids such as acetic acid or free fatty acids which are released from the food product. These acidic compounds have proved to be capable of penetrating the inside of the packaging laminate but not the aluminium foil. In such instance, they accumulate in a steadily increasing concentration adjacent the aluminium foil and, gradually during the long shelf-life which the packaging container nevertheless displays, have a negative effect on the bonding and adhesion between the aluminium foil and the liquid-tight inside coating based on polypropylene. In the worst case scenario, there is a risk that this bonding is released entirely so that the inside coating based on polypropylene forms a loose bag inside the packaging container.

EP 0 341 937 describes a packaging laminate in which an extra barrier layer of ethylene vinyl alcohol copolymer (EVOH) has been provided between an ordinary oxygen gas barrier of aluminium foil and an inner sealing layer of polyethylene. The purpose is stated to be to provide an additional barrier protection for the total container structure, but it is not disclosed that such an additional barrier layer could function against acidic compounds nor is there any disclosure or description of a packaging laminate for a retortable or hot fillable packaging container.

### BRIEF OUTLINE OF THE INVENTION

One object of the present invention is to obviate the above-outlined problems in association with the prior art packaging laminate.

A further object of the present invention is to provide a packaging laminate of the type described by way of introduction which may readily be reformed by fold forming and thermosealing into a retortable or hot fillable packaging container without the risk that the packaging container loses its desirable tightness properties against gases, in particular oxygen gas.

Yet a further object of the present invention is to realise a retortable or hot fillable packaging container produced from the packaging laminate for perishable or oxygen gas-sensitive food products, this packaging container retaining superior adhesion and bonding between its oxygen gas barrier of aluminium foil and the outer liquid-tight coating on the inside of the laminate, also during a lengthy period of storage with a content of a food product which contains, is preserved in or emits one or more acidic compounds.

These and other objects and advantages will be attained according to the present invention by means of a packaging laminate, a packaging container and a method in the production of the packaging container according to the appended Claims.

Hence, the present invention realises a packaging laminate for a retortable or hot fillable packaging container, the packaging laminate comprising a core layer of paper or paperboard, a first outer liquid-tight coating based on polypropylene on the inside of the packaging laminate, a second outer liquid-tight coating based on polypropylene on the outside of the packaging laminate, an aluminium foil serving as gas barrier between the core layer and said first outer liquid-tight coating based on polypropylene, there being provided, according to the present invention, a layer of polar polymer material serving as barrier against acidic compounds and disposed between the aluminium foil and said first outer liquid-tight coating based on polypropylene.

According to one aspect of the present invention, the layer serving as barrier against acidic compounds is selected from the group essentially comprising polyethylene terephthalate (PET), amorphous polyethylene terephthalate (APET), oriented polyethylene terephthalate (OPET), polyamide (PA), amorphous polyamide (APA), oriented polyamide (OPA), ethylene vinyl alcohol copolymer (EVOH), polyvinyl alcohol (PVOH) or combinations thereof. One such, particularly preferred, combination may be ethylene vinyl alcohol copolymer (EVOH) together with polyamide (PA). It is also conceivable that the layer serving as barrier against acidic compounds may include a scavenger for acidic compounds, such a compound which is rich in OH groups. The function of the layer serving as barrier against acidic compounds is that, during the shelf-life of the packaging container, it prevents, to a sufficient degree, acidic compounds from the food product from reaching the aluminium foil. As a result, a sufficiently good level of bonding and adhesion will be maintained between the aluminium foil and the outer liquid-tight coating based on polypropylene on the inside of the laminate.

The thickness of the layer serving as barrier to acidic compounds is suitably between 5 and 25 μm, preferably between 7 and 20 μm and even more preferably between 10 and 15 μm. Further, the layer serving as barrier against acidic compounds is preferably directly bonded to the aluminium foil via an interjacent tie layer of an adhesive such as, for example, an adhesion plastic. One particularly preferred adhesive according to the present invention is that which may be obtained from Mitsui, Japan, under the trade name Admer.

According to one aspect of the present invention, the first outer liquid-tight coating based on polypropylene on the inside of the packaging laminate displays a thickness of between 20 and 60 μm, preferably between 25 and 40 μm. The second outer liquid-tight coating based on polypropylene on the outside of the packaging laminate displays a thickness of between 30 and 50 μm, preferably between 33 and 45 μm.

According to one preferred embodiment of the present invention, there may be provided a third layer based on polypropylene between the core layer and the aluminium foil, this third layer based on polypropylene being preferably disposed direct against the core layer without any interjacent layer, and preferably displays a thickness of between 5 and 20 μm, and even more preferably between 8 and 16 μm.

According to one embodiment of the present invention, an additional layer serving as gas barrier is disposed between the core layer and the aluminium foil, this additional layer serving as gas barrier being directly bonded to said aluminium foil via an interjacent tie layer of an adhesive, for example an adhesion plastic such as Admer. This additional layer serving as gas barrier consists of a material selected among the group essentially comprising polyethylene terephthalate (PET), amorphous polyethylene terephthalate (APET), cyclic olefin copolymers (COC), polyamide (PA), polyamide copolymer (PA-copolymer) amorphous polyamide (APA), liquid crystalline polymers (LCP), ethylene vinyl alcohol copolymer (EVOH) and polyvinyl alcohol (PVOH) which may possibly be applied on a thin carrier layer, such as, for example, paper. Suitably, it displays a thickness of between 5 and 20 μm, preferably between 5 and 15 μm.

While a packaging container which is produced by fold forming and sealing of a conventional packaging laminate not seldom loses desirable tightness properties against gases, in particular oxygen gas, because of cracks which may occur in the aluminium foil when the packaging laminate is reformed into a packaging container, this risk is counteracted or effectively obviated by the layer employed as additional gas barrier between the core layer and the aluminium foil in this embodiment of the packaging laminate according to the present invention.

Where necessary, further tie layers of an adhesive, for example an adhesion plastic such as Admer, are provided between the different layers in the laminate.

All layers in the packaging laminate are of qualities which are particularly suitable for retorting or hot filling.

The present invention further realises a retortable or hot fillable packaging container for particularly perishable and oxygen gas-sensitive products produced by fold forming and sealing of the packaging laminate according to the present invention.

Further, the present invention realises a method, in the production of such a packaging container with contents consisting of a food, the packaging container displaying long shelf-life and such packaging container being treated by retorting.

According to one variation, the present invention realises a method, in the production of a packaging container with contents consisting of food, the packaging container displaying long shelf-life and in which the filling of food into the packaging container is carried out at least 80° C. but below 100° C., whereafter the packaging container is sealed.

### BRIEF DESCRIPTION OF THE ACCOMPANYING DRAWINGS

The present invention will now be described in greater detail hereinbelow, with reference to the preferred embodiment and with reference to the accompanying Drawings. In the accompanying Drawings:

FIG. 1 schematically illustrates the general structure of a packaging laminate for a retortable or hot fillable packaging container according to a first embodiment of the present invention; and

FIG. 2 schematically illustrates the general structure of a packaging laminate for a retortable or hot fillable packaging container according to a second embodiment of the present invention.

### DETAILED DESCRIPTION OF THE ACCOMPANYING DRAWINGS AND PREFERRED EMBODIMENTS

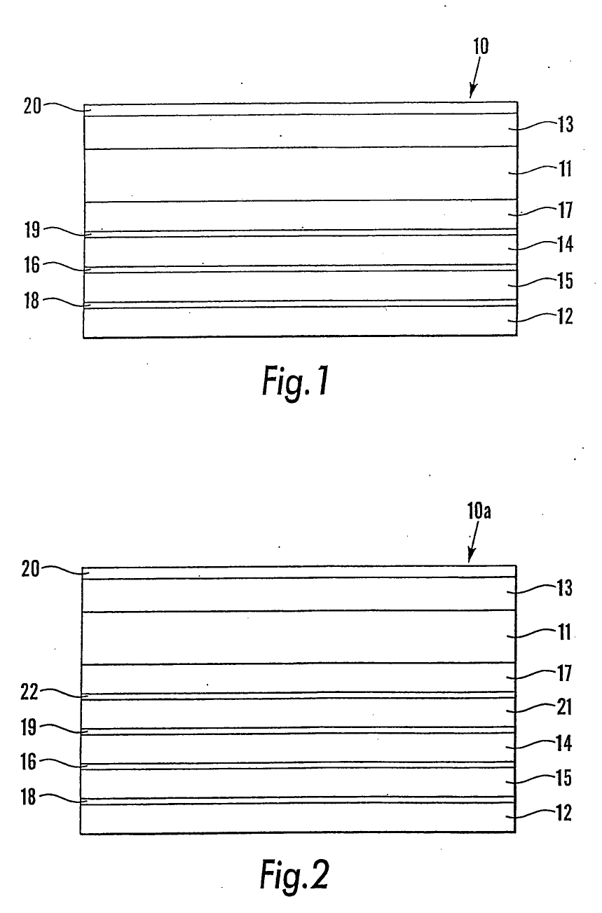

FIG. 1 shows the general structure of a packaging laminate according to the present invention carrying the generic reference numeral 10. The packaging laminate 10 has a rigid, but foldable core layer 11 of paper or paperboard, as well as outer liquid-tight coatings 12 and 13 based on polypropylene on both sides of the core layer 11. The packaging laminate 10 further displays an aluminium foil 14 serving as gas barrier and disposed between the core layer 11 and the one outer liquid-tight coating 12, i.e. the first outer liquid-tight coating 12 which will constitute the inside of the packaging container formed from the laminate and will be in direct contact with the food therein. A third layer 17 based on polypropylene is disposed between the core layer 11 and the gas barrier layer 14. According to the present invention, there is further provided a layer 15 serving as barrier against acidic compounds and consisting of polar polymer material, this layer 15 being disposed between the gas barrier layer 14 and said first outer liquid-tight coating 12 based on polypropylene.

The second outer liquid-tight coating 13 which will constitute the outside in the packaging container is a polypropylene based (PP) plastic. The liquid-tight coating 13 may, for example, consist of a physical or mechanical mixture of polypropylene (PP) and polyethylene (PE) which, in addition to superior tightness properties against liquid, also displays sufficient moisture and heat resistance to be able to withstand such extreme moisture and temperature stresses as occur in a normal heat treatment in a retort with a view to extending shelf-life. An outer coating 13 of a physical or mechanical mixture of polypropylene (PP) and polyethylene (PE) moreover displays good printability at the same time as making for mechanically strong and liquid-tight seals by thermosealing when the packaging laminate 10 is reformed into a retortable packaging container. The thickness of the outer liquid-tight coating 13 is generally of the order of magnitude of between 30 and 50 μm.

On the outside of the outer liquid-tight coating 13, there are provided printed artwork and a protective lacquer 20.

The first outer liquid-tight coating 12, which will constitute the inside of the packaging container, also consists of a polypropylene based plastic. Preferably, the liquid-tight coating 12 consists of a copolymer of propylene and ethylene which is sufficiently moisture- and heat resistant to withstand the extreme moisture- and temperature stresses which occur in a normal heat treatment in a retort with a view to extending shelf-life. A coating of a copolymer of propylene and ethylene moreover makes for mechanically strong and liquid-tight seals when the packaging laminate 10 is reformed into a packaging container for retorting purposes. The thickness of the outer plastic coating 12 is generally of the order of magnitude of between 20 and 60 μm.

The layer 17 also consists of a polypropylene based plastic. This layer is disposed in direct contact with the core layer 11 and, via a tie layer 19, bonds to the gas barrier layer 14 of aluminium foil. Typically, the layer 17 may display a thickness of between 5 and 20 μm.

Typically, the gas barrier layer of aluminium displays a thickness of between 6 and 12 μm.

The layer 15 of polar polymer material serving as barrier against acidic compounds according to the present invention is, possibly via a tie layer 16, directly bonded to the gas barrier layer 14 of aluminium, on its inside. It is also directly bonded to the first outer liquid-tight coating 12, via a tie layer 18. The layer 15 may consist of a material as described above, but in the preferred embodiment it consists of EVOH or a combination of EVOH and PA. In general, it displays a thickness of between 5 and 25 μm.

The packaging laminate 10a in FIG. 2 principally differs from the packaging laminate 10 in FIG. 1 in that it displays, between the aluminium foil 14 and the core layer 11 (or the third polypropylene based layer 17), an additional layer 21 serving as gas barrier in order to compensate for or counteract any possible cracks which may occur in the aluminium foil 14 when the packaging laminate 10a is reformed into a packaging container. A tie layer 22 is suitably provided between the additional layer 21 serving as gas barrier and the third polypropylene based layer 17. On its other side, the additional layer 21 serving as gas barrier directly bonds via the tie layer 19 to the gas barrier layer 14 of aluminium.

Preferred materials for the additional or supplementary gas barrier layer 21 in the packaging laminate 10a according to the present invention have been described above. Its thickness is generally of the order of magnitude of between 5 and 20 μm.

The packaging laminate according to the present invention may be produced in that the outside of the laminate, i.e. the layers 13 and 11, are laminated to the aluminium foil 14 by means of co-extrusion therebetween of the layers 17, possibly 22, possibly 21 and 19. The inside may thereafter be applied by extrusion, preferably co-extrusion, of the layers 16, 15, 18 and 12 on the inside of the gas barrier layer 14 of aluminium. Alternatively, the inside layers 16, 15, 18 and 12 have been prefabricated in the form of a film which is preferably laminated to the aluminium foil 14 in the same nip as the lamination of the outside 13, 11 to the aluminium foil 14, or alternatively in another nip.

From the packaging laminate 10, 10a, a retortable packaging container is produced in a per se known manner by fold forming and thermosealing of a sheet- or web shaped blank of the packaging laminate 10, 10a as described under the heading “Background art” above.

Naturally, the present invention is not restricted exclusively to the embodiments described and illustrated by way of example, numerous various alterations and modifications being possible without departing from the scope of the inventive concept as this is defined in the appended Claims.

1. A packaging laminate for a retortable or hot fillable packaging container, the packaging laminate comprising a core layer of paper or paperboard, a first outer liquid-tight coating based on polypropylene on an inside of the packaging laminate, a second outer liquid-tight coating based on polypropylene on an outside of the packaging laminate, an aluminium foil serving as gas barrier between the core layer and said first outer liquid-tight coating based on polypropylene, and a layer of polar polymer material serving as barrier against acidic compounds and disposed between the aluminium foil and said first outer liquid-tight coating based on polypropylene.

2. The packaging laminate as claimed in claim 1, wherein the layer serving as the barrier against acidic compounds is chosen from the group essentially comprising polyethylene terephthalate (PET), amorphous polyethylene terephthalate (APET), oriented polyethylene terephthalate (OPET), polyamide (PA), polyamide copolymer (PA-copolymer), amorphous polyamide (APA), oriented polyamide (OPA), ethylene vinyl alcohol copolymer (EVOH), polyvinyl alcohol (PVOH) or combinations thereof.

3. The packaging laminate as claimed in claim 1 wherein the layer serving as the barrier against acidic compounds includes a scavenger for acidic compounds.

4. The packaging laminate as claimed in claim 1, wherein a thickness of the layer serving as the barrier against acidic compounds is between 5 and 25 μm.

5. The packaging laminate as claimed in claim 1, wherein the layer serving as the barrier against acidic compounds is directly bonded to said aluminium foil via an interjacent tie layer.

6. The packaging laminate as claimed in claim 1, wherein said first outer liquid-tight coating based on polypropylene on the inside of the packaging laminate displays a thickness of between 20 and 60 μm.

7. The packaging laminate as claimed in claim 1, wherein said second outer liquid-tight coating based on polypropylene on the outside of the packaging laminate displays a thickness of between 30 and 50 μm.

8. The packaging laminate as claimed in claim 1, further comprising a third layer based on polypropylene between said core layer and said aluminium foil, said third layer based on polypropylene being disposed direct against said core layer.

9. The packaging laminate as claimed in claim 1, further comprising an additional layer serving as a gas barrier between the core layer and the aluminium foil, said additional layer serving as the gas barrier being directly bonded to said aluminium foil via an interjacent tie layer.

10. The packaging laminate as claimed in claim 9, wherein said at least one additional layer serving as the gas barrier consists of a material selected from the group essentially comprising polyethylene terephthalate, amorphous polyethylene terephthalate (APET), cyclic olefin copolymers (COC), polyamide (PA), amorphous polyamide (APA), liquid crystalline polymers (LCP), ethylene vinyl alcohol copolymer (EVOH) and polyvinyl alcohol (PVOH).

11. The packaging laminate as claimed in claim 9, wherein the thickness of said at least one additional layer serving as the gas barrier is between 5 and 20 μm.

12. A packaging container that it is fold formed from a packaging laminate as claimed in claim 1, filled with a food and sealed.

13. A method of producing a packaging container with food contents, the packaging container displaying long shelf-life, the packaging container being the packaging container as claimed in claim 12 and being treated by retorting.

14. A method in the production of a packaging container with food contents, the packaging container displaying extended shelf-life, wherein the filling of the food into a packaging container as claimed in claim 12 is carried out at least 80° C., but less than 100° C., whereafter the packaging container is sealed.

15. The packaging laminate as claimed in claim 1, wherein a thickness of the layer serving as barrier against acidic compounds is between 7 and 20 μm.

16. The packaging laminate as claimed in claim 1, wherein a thickness of the layer serving as barrier against acidic compounds is between 10 and 15 μm.

17. The packaging laminate as claimed in claim 1, wherein said first outer liquid-tight coating based on polypropylene on the inside of the packaging laminate displays a thickness of between 25 and 40 μm.

18. The packaging laminate as claimed in claim 1, wherein said second outer liquid-tight coating based on polypropylene on the outside of the packaging laminate displays a thickness of between 33 and 45 μm.

19. The packaging laminate as claimed in claim 8, wherein said third layer based on polypropylene possesses a thickness of between 5 and 20 μm.

20. The packaging laminate as claimed in claim 8, wherein said third layer based on polypropylene possesses a thickness of between 8 and 16 μm.
